(19) United States
(12) Patent Application Publication
(10) Pub. No.: US 2007/0117877 A1
(43) Pub. Date: May 24, 2007

(54) Process for curing polyurethane adhesives/sealants

(76) Inventors: Manfred Rein, Hirschberg (DE); Karl-Wilhelm Schrade, Oldenburg (DE)

Correspondence Address: HENKEL CORPORATION, THE TRIAD, SUITE 200, 2200 RENAISSANCE BLVD., GULPH MILLS, PA, 19406, US

(21) Appl. No.: 11/400,660

(22) Filed: Apr. 7, 2006

(30) Foreign Application Priority Data
Apr. 18, 2005 (DE) DE 10200517912.6

(51) Int. Cl. C08G 18/67

(52) U.S. Cl. 522/90

(57) ABSTRACT

One component adhesives/sealants comprising surface-deactivated solid polyisocyanates and, optionally, isocyanate-reactive, liquid binders can be rapidly cured below the conventional thickening temperature by irradiating with microwaves, for example microwaves of at least 2 wavelengths. This process is particularly suitable for adhesively joining plastic substrates.

### CROSS-REFERENCE TO RELATED APPLICATIONS

This application claims priority under 35 U.S.C. Section 119 to German application DE 10200517912.6, filed 18 Apr. 2005.

### FIELD OF THE INVENTION

The subject of the invention is a process for curing one-component adhesives/sealants comprising surface-deactivated solid polyisocyanates by means of microwave radiation, as well as the use of this process for adhesively joining plastic substrates

### DISCUSSION OF THE RELATED ART

In modern industrial production, there is often the need to bond plastic substrates together by adhesion. More and more frequently, especially in the automobile industry, parts and modules, such as lamp housings or automobile headlights, are manufactured from plastics. For this, older joining processes are known, in which a headlight housing has a U-shaped sealing bed on a first side wall into which a second part, for example a closure or a covering device of glass having a second side wall, is inserted such that both parts are sealed and joined together. Nowadays, lenses of plastic substrates, for example of polymethyl methacrylate (PMMA) or polycarbonate (PC), are frequently used instead of glass closures or covering lenses or also headlight lenses.

Today, plastics are often bonded together by means of 2-component products that cure at room temperature. This is often due to the fact that the substrates suffer thermal damage at high temperatures and consequently cannot tolerate adhesives that imperatively require these temperatures to reach their final strength. At room temperature, the curing is indeed substrate-friendly, but takes much longer than high temperature curing. This problem can be mitigated by using 2-component products with a short pot-life. However, this advantage is achieved at an additional cost to the application (more frequent changes of static mixers or/and cleaning out mixed material). A further advantage can be obtained if, after application, at least a handling strength can be achieved by means of an energy input, e.g. by thermal energy in a circulating-air oven or by the use of hot-air techniques or even by radiation energy (e.g., infra-red heating). These measures only partially solve the problem, however, and require the use of expensive equipment. A one-component product that is substrate-friendly at relatively low temperatures and which almost reaches its complete final strength in a relatively short time would be a favorable solution to the problem.

One-component polyurethanes based on microencapsulated isocyanate have been known for about 20 years and have been introduced in the market in the form of various adhesives and sealants for automobiles and commercial vehicles. In this field, the state of the art for curing these products is by means of thermal energy, e.g., in a circulating-air oven, through which the automobile bodies is in any case must transit to dry/cure the priming coat, fillers or paints. In particular cases—mostly for mounted parts—the hot air method can be used, whereby the hot air is only blown onto the area of e.g. glue lines.

A process for bonding moldings with heat-curable adhesives by irradiating the adhesive joint with electromagnetic radiation is described in WO 03/076167. The adhesive joint should be such that in the region of the adhesive joint, at least one of the moldings of the substrate is transparent to electromagnet radiation, particularly infrared radiation. The mass of the adhesive in the adhesive joint should then be irradiated with energy-rich infrared radiation (near Infrared (NIR)). Heat curable adhesives, based on a non-aqueous dispersion, which comprise one polyisocyanate that is deactivated only on the surface and at least one polymer that is reactive to isocyanate are proposed as the adhesive. A disadvantage of this process is that the adhesive joint should be such that at least one of the moldings to be joined is transparent to IR-radiation in the region of the adhesive joint. A further disadvantage is that the IR-radiation not only heats the adhesive, but very frequently also the region of the mounted part close to the adhesive.

Apart from these conventional methods, microwave curing of polyurethanes has proven to be particularly advantageous when raw materials that are suitable for microwave cure are used together with conditions for this method that are favorable to highly active catalysts. In this case it is also possible to realize good and durable adhesion on critical primer coatings that, due to their low surface tension, are difficult to wet.

Accordingly, there was the need to provide further processes to bond plastic molded parts, enabling a rapid adhesion and production process leading to a durable bond of the mounted parts, and which are less dependent on special constructive limitations in relation to the transparency to activating radiation.

The use of microwave irradiation for curing sealants and adhesives is understood in principle, thus a process to at least partially cure sealants and is adhesives, particularly in connection with the direct glazing of motor vehicles, is described in EP 318542 B1, the sealant and adhesive being heated by irradiation with microwave energy. For this, the application of the microwave energy should be localized and the microwave energy should be applied in a pulse-like manner in a first and at least a further group, the amplitude of each group being lower at the end than at the start of the group, and continuous microwave energy is applied for a period between the impulse groups. The constituents of the binding agent comprise isocyanate-functional reaction products from a stoichiometric excess of aromatic isocyanates with a polyol. Complexed amines, particularly the complex of methylenedianiline and common salt, are proposed as the heat-activatable crosslinking agents. In this document, microencapsulated polyamino or polyhydroxy functional compounds, which are consequently unavailable for reaction with the isocyanate prepolymers at room temperature, are proposed as additional crosslinking agents. These types of crosslinking agent need material temperatures above 100° C., advantageously between 120 and 160° C., to initiate the crosslinking reaction.

A method of dispensing adhesives onto a substrate, wherein the adhesive is heated by microwave energy immediately before being dispensed onto the substrate, is described in U.S. Pat. No. 5,948,194. For this, the material is conveyed under pressure through a dispensing tube that is transparent to microwave energy. The dispensing tube is located within a microwave resonant chamber. The microwave energy is channeled from a microwave-generating source along a waveguide to the microwave resonant chamber, wherein the adhesive, on passing though the resonance chamber, undergoes negligible heating at the radial boundaries of the dispensing tube. The adhesive is subsequently dispensed onto the component along a predetermined path. The material has to be heated to different temperatures along the applied adhesive trail. General information on the compositions of adhesives that are suitable for this process is not available from this document.

A method of facilitating the adhesive bonding of various components with variable frequency microwave energy is disclosed in U.S. Pat. No. 5,804,801 A. According to this document, the time required to cure a polymeric adhesive is decreased by placing components to be bonded by the adhesive in a microwave heating apparatus having a multimode cavity and irradiated with microwaves of varying frequencies. This method provides uniform heating for various articles comprising conductive fibers. Microwave energy may be selectively oriented to enter an edge portion of an article comprising conductive fibers. Other edge portions of an article can be selectively shielded from the microwaves. Epoxy resin adhesives are disclosed as useable adhesives.

Liquid, reactive, heat-curable compositions from a polyepoxide, a di or polycarboxylic acid, together with a catalyst that effects a rapid polymerization of the epoxide and anhydride mixture under microwave irradiation are described in EP 0720995 B1.

A method of accelerating adhesive curing by the use of adhesive m compositions that comprise nano-particles having ferromagnetic, ferrimagnetic, super paramagnetic or piezoelectric properties, that under the influence of an electric or magnetic or electromagnetic alternating field are heated up in such a way that the binding agent matrix in reactive adhesives is heated to a temperature that effects the crosslinking of the binding agent matrix through the reactive groups of the binding agent, is described in WO 02/12405. In this document, low frequency regions from about 50 kHz up to about 100 kHz are proposed as the electromagnetic radiation for heating the adhesive composition by the nano-particles.

A method and a device for curing, crosslinking and/or drying coating materials and/or substrates, and a novel use of a microwave oven that is characterized by the use of microwaves with at least two wavelengths, is described in EP 1327844 A2.

### BRIEF SUMMARY OF THE INVENTION

The present invention provides a process for curing one-component adhesive/sealing compositions that cure by means of microwave radiation. More specifically, the subject of the present invention relates to a process for curing one-component adhesives/sealants comprising surface-deactivated polyisocyanates that are solid at room temperature by means of microwave radiation, and which is furnished in such a way that the adhesive/sealant composition is macroscopically heated only to a temperature below the thickening temperature.

### DETAILED DESCRIPTION OF CERTAIN EMBODIMENTS OF THE INVENTION

In the context of this invention, the “thickening temperature” is the temperature to which a room temperature, shelf stable composition that comprises a surface deactivated isocyanate must be heated for a short time, that is up to an hour, in order to produce a polyaddition reaction and hence crosslinking. The polyaddition reaction and/or crosslinking is recognized by a significant “thickening”, i.e., by the solidification of the material. In the context of this invention, the thickening temperature can be determined by placing the composition to be tested in an oven at a predetermined temperature and measuring the consistency of the composition as a function of time and temperature. A further possibility is to apply a trail of material onto a Kofler heating plate, i.e., a surface that exhibits a specified temperature gradient. In this way, the thickening temperature can be defined as the frontier between pasty and crosslinked material. The simplest method of determination is a viscosity measurement at defined increasing temperatures of the measurement plate. In this case the thickening temperature is defined as the value that can be read after initiation of the curing reaction by extending the almost vertically rising branch of the viscosity curve onto the temperature axis.

The “material temperature” of the adhesive/sealant composition that is heated by microwave radiation according to the inventive process is understood to mean the temperature measured at the surface of the composition of the horizontal adhesive trails (1 cm wide, 0.5 cm high) immediately after they have left the microwave radiation.

In a preferred embodiment of the process according to the invention, the microwave radiation impinging on the adhesive composition is controlled such that, in the sense of the above definition, material temperatures between 40° C. and 120° C. are attained, the material temperature being preferably between 50 and 70° C.

In the context of this invention, “microwaves” are understood to mean electromagnetic radiation in the frequency range between 300 MHz and 300 GHz, i.e., electromagnetic rays between the high frequency region of radio waves and infrared radiation. In particular, the “microwave radiation” region in the context of this invention includes the regions of decimeter waves with frequencies between 300 MHz and 3 GHz and the centimeter waves with frequencies between 3 GHz and 30 GHz and may, however, also include the region of millimeter waves between 30 GHz and 300 GHz

In preferred embodiments of the process according to the invention, it is preferred to irradiate the adhesive/sealant composition with microwaves with at least two wavelengths, wherein the at least two wavelengths of the microwaves are generated by switching on microwave-producing microwave sources, the switching on being optionally periodic, and the energy of the radiating microwaves is preferably controlled as a function of the resulting adhesive/sealant temperature and/or the state of cure of the polyurethane binding agent system.

With advancing curing of the binding agent system, the quantity of microwave energy reflected from the irradiated adhesive joint increases, such that the irradiated energy must be reduced by means of a suitable feedback control system, so as to avoid overheating. In order to obtain the most complete cure possible of the adhesive/sealant in the adhesive joint under the mildest possible conditions, it has to be ensured that the emittance of the microwave energy takes place in such a way that the microwave energy reaches the total volume of the adhesive so that the crosslinking reaction can be initiated.

For this, the substrate provided with the adhesive/sealant can be successively conveyed through zones that are irradiated with microwaves having an identical fundamental frequency, preferably about 2.5 GHz, and which are modulated with different modulation frequencies, preferably with about 900 MHz, about 1.2 GHz, about 1.6 GHz, about 1.9 GHz, about 2.2 GHz, about 2.5 GHz and/or about 3 GHz.

Devices that are suitable for the inventive process of adhering plastic components with the use of one-component adhesives/sealants comprising surface deactivated solid polyisocyanates are described, for example, in EP 1327844 A2. The disclosure of this document in relation to the design of the device is expressly incorporated as a component of the present process.

For small components or for low surface area adhesive joints, the devices for the inventive process to adhere plastic components can be set up in such a way that the microwave emitter, together with a dispensing device, is conveyed on an arm of a robot along the region of the substrate provided with adhesive and to be joined, such that the process can be extensively automated.

The solid, surface deactivated polyisocyanates which are used in the adhesive/sealants according to the inventive process preferably have a melting point above 40° C. The polyisocyanates listed below are particularly suitable: Diphenylmethane-4,4′-diisocyanate (MDI), naphthalene-1,5-diisocyanate (NDI), 3,3′-dimethyl-biphenyl-4,4′-diisocyanate (TODI), dimeric 1-methyl-2,4-phenylene diisocyanate (TDI-U), 3,3′-diisocyanato-4,4′dimethyl-N,N′-diphenylurea (TDIH), the isocyanurate of IPDI (IPDI-T) or the addition product of 2 moles 1-methyl-2,4-phenylene diisocyanate with 1 mole 1,2-ethanediol, 1,4-butanediol, 1,4-cyclohexane dimethanol or ethanolamine.

The surface deactivation of these solid powdered polyisocyanates is carried out by the known method of dispersing the powdered polyisocyanates in a solution or dispersion of a deactivating agent.

The solid polyisocyanates should preferably be in powder form with an average particle size diameter of less than or equal to 10 μm (weight average). As a rule, they occur as a powder having the required particle sizes of 10 μm or less from their synthesis; in other cases the solid polyisocyanates have to be converted (prior to deactivation) to the inventive particle size range by milling processes and/or sieving processes. The processes are state of the art.

Alternatively, the powdered polyisocyanates can be converted to an average particle size of equal to or less than 10 μm by a wet milling and fine dispersion subsequent to the surface deactivation. Dispersion equipment of the rotor-stator type, agitator ball mills, bead and sand mills, ball mills and friction mills are suitable. According to the polyisocyanate and usage, the grinding of the deactivated polyisocyanate may occur in the presence of the deactivator or in non-reactive dispersing agents followed by deactivation. The ground and surface-stabilized polyisocyanate is also separated from the grinding dispersion and optionally dried. The process is described in EP 204 970.

The surface deactivation reaction can be carried out in various ways:
By dispersing the powdered isocyanate in a solution of the deactivator.
By incorporating a melt of a low-melting polyisocyanate into a solution of the deactivator in a non-dissolving liquid dispersant.
By adding the deactivator or a solution of it to the dispersion of the solid, finely divided isocyanate.

The solid polyisocyanates are preferably deactivated by the action of primary and secondary aliphatic mono-, di- or polyamines, hydrazine derivatives, amidines, and/or guanidines. Ethylenediamine, 1,3-propylenediamine, diethylenetriamine, triethylenetetramine, 2,5-dimethylpiperazine, 3,3′-dimethyl-4,4′-diamino-dicyclohexylmethane, methylnonanediamine, isophoronediamine, 4,4′-diaminodicyclohexylmethane, diamino and triaminopolypropylene ethers, polyamidoamines (also known as polyaminoamides), and mixtures of mono-, di- and polyamines have proved their worth. Aminoalkyl alkoxysilanes, such as for example the 3-aminopropyl triethoxysilane or the corresponding alkyl dialkyloxysilanes or other aminoalkyl alkoxysilanes as well as aminofunctional polybutadienes or polyisoprenes are also suitable. The above amino terminated polypropylene glycols, polyethylene glycols or copolymers of propylene glycol and ethylene glycol are quite particularly preferred. Mixtures of the above deactivators may also be used.

The concentration of the deactivator should be 0.1 to 20, preferably 0.5 to 8 equivalent percent, based on the total number of isocyanate groups.

Accordingly, the binding agent of the microwave-curable adhesive/sealant comprises polyols such as, e.g., polyether polyols, polyester polyols, polyacrylate polyols, polyolefin polyols and/or polyether ester polyols, polyether amines, substituted aromatic diamines and a finely divided solid di- or polyisocyanate that is surface deactivated during the dispersion in the polyol/polyamine mixture.

In addition to the abovementioned constituents, typically the adhesive/sealant comprises fillers, an optionally powdered molecular sieve or other water-binding components, and/or catalysts.

A large number of higher molecular weight polyhydroxy compounds can be used as polyols. Room temperature-liquid polyethers having two or three hydroxyl groups per molecule and in the molecular weight range of 400 to 30,000, preferably in the range 1000 to 15,000, are advantageously suitable as polyols. Examples are di and/or trifunctional polypropylene glycols; also statistical and/or block copolymers of ethylene oxide and propylene oxide may be used. A further group of advantageously usable polyethers are the polytetramethylene glycols (poly(oxytetramethylene) glycols, poly-THF), which, e.g., are prepared by acidic polymerization of tetrahydrofuran. In this case the molecular weight range of the polytetramethylene glycols is between 200 and 6000, preferably in the range 800 to 5000. Further suitable polyols are the liquid, glassy amorphous or crystalline polyesters that can be manufactured by condensing di or tricarboxylic acids, such as, e.g., adipic acid, sebacic acid, glutaric acid, azelaic acid, cork acid, undecanedioic acid, dodecanedioic acid, 3,3-dimethylglutaric acid, terephthalic acid, isophthalic acid, hexahydrophthalic acid, dimer fatty acids or their mixtures with diols or triols such as, e.g., ethylene glycol, propylene glycol, diethylene glycol, triethylene glycol, dipropylene glycol, 1,4-butanediol, 1,6-hexanediol, 1,8-octanediol, 1,10-decanediol, 1,12-dodecanediol, dimer fatty alcohols, glycerin, trimethylolpropane or their mixtures. A further group of inventively applicable polyols is the polyesters based on ε-caprolactone, also known as “polycaprolactones”. However, polyester polyols of oleochemical origin may also be used. Such types of polyester polyols can be manufactured by the total ring opening of epoxidized triglycerides of a fat mixture comprising at least partially olefinically unsaturated fatty acids with one or more alcohols having 1 to 12 carbon atoms and subsequently partially transesterifying the triglyceride derivatives to alkyl ester polyols having 1 to 12 carbon atoms in the alkyl group. Further suitable polyols that are used as polyols are polycarbonate polyols and dimer diols (Henkel) as well as advantageously castor oil and its derivatives and/or hydroxy-functional polybutadienes as are obtainable under the trade name “Poly-bd”. Besides the abovementioned hydroxy-functional polybutadienes, hydroxy-functional polyisoprenes, as well as the corresponding hydroxy-functional copolymers of butadiene or isoprene with styrene, as well as the hydrogenated products of hydroxy-functional polybutadienes, polyisoprenes or their copolymers may also be used.

In addition, linear and/or weakly branched acrylic ester copolymer polyols that can be manufactured, for example, by the radical copolymerization of acrylic acid esters or methacrylic acid esters with hydroxy-functional acrylic acid- and/or methacrylic acid compounds, such as hydroxyethyl methacrylate or hydroxypropyl (meth)acrylate, are also suitable as the polyols. Due to their manufacturing process, the hydroxyl groups in these polyols are usually statistically distributed, so that they are either linear or weakly branched polyols with an average OH functionality. The hydroxy-functional binding agent component can also comprise mixtures of one or a plurality of the abovementioned polyols. Amino terminated polyalkylene glycols, particularly the difunctional amino terminated polypropylene glycols, polyethylene glycols or copolymers of propylene glycol and ethylene glycol can be preferably added as the di or trifunctional amino terminated polymers. They are also known by the name “Jeffamine” (trade name of the Huntsman Petrochemical Corporation). In addition, the difunctional amino terminated polyoxytetramethylene glycols, also called poly-THF, are suitable. The difunctional amino terminated polybutadiene compounds are also suitable building blocks, together with aminobenzoic acid esters of polypropylene glycols, polyethylene glycols or poly-THF (known under the trade name “Versalink oligomeric diamines” of Air Products & Chemicals, Inc.). The molecular weights of the amino terminated polyalkylene glycols or polybutadienes are typically between 400 and 6000.

Similarly, substituted aromatic diamines, which are known under the trade names Lonzacure (Lonza) or Unilink (UOP), can also be used.

Chalks, natural, ground or precipitated calcium carbonates, calcium magnesium carbonates (Dolomite), silicates such as, e.g., aluminum silicates, barites or magnesium aluminum silicates or also talc are preferably used as the fillers. In addition, other fillers, in particular reinforcing fillers like carbon blacks, selected from the group of flame blacks, channel blacks, gas blacks or furnace blacks or their mixtures can be optionally used with the above fillers. The adhesives/sealants according to the present invention can additionally comprise plasticizers or plasticizer mixtures as well as catalysts, stabilizers and other auxiliaries and additives.

Tertiary amines, particularly aliphatic cyclic amines, are suitable catalysts. Under the tertiary amines, those that are also suitable, carry additional groups, particularly hydroxyl and/or amino groups, which are reactive towards isocyanates. Practical examples are: dimethylmonoethanolamine, diethylmonoethanolamine, methylethylmonoethanolamine, triethanolamine, trimethanolamine, tripropanolamine, tributanolamine, trihexanolamine, tripentanolamine, tricyclohexanolamine, diethanolmethylamine, diethanolethylamine, diethanolpropylamine, diethanolbutylamine, diethanolpentylamine, diethanolhexylamine, diethanolcyclohexylamine, diethanolphenylamine as well as their ethoxylation and propoxylation products, diaza-bicyclo-octane (DABCO), triethylamine, dimethylbenzylamine (DESMORAPID DB, Bayer), bis-dimethylaminoethyl ether (catalyst A 1, UCC), tetramethylguanidine, bis-dimethylaminomethylphenol, 2-(2-dimethylaminoethoxy)ethanol, 2-dimethylaminoethyl-3-dimethylaminopropyl ether, bis(2-dimethylaminoethyl) ether, N,N-dimethylpiperazine, N-(2-hydroxyethoxyethyl)-2-azanorbornane, or also unsaturated bicyclic amines, e.g. diazabicycloundecene (DBU) as well as TEXACAT DP-914 (Texaco Chemical), N,N,N,N-tetramethylbutane-1,3-diamine, N,N,N,N-tetramethylpropane-1,3-diamine and N,N,N,N-tetramethylhexane-1,6-diamine.

The organometallic compounds commonly known in polyurethane chemistry can also be used as catalysts, such as, for example iron or also particularly tin or bismuth compounds. Specific examples of them are 1,3-dicarbonyl compounds of iron, like iron (III) acetylacetonate, as well as in particular the organotin compounds of 2- or 4-valent tin, in particular the Sn(II) carboxylates or the dialkylSn(IV) dicarboxylates or the corresponding dialkoxylates such as, e.g., dibutyltin dilaurate, dibutyltin diacetate, dimethyltin dineodecanoate, dioctyltin diacetate, dibutyltin maleate, tin(II) octoate, tin(II) phenolate or also the acetylacetonates of 2- or 4-valent tin. Optionally, mixtures of the abovementioned tertiary amines with the organometallic compounds can also be added as catalysts.

Lightweight fillers can also be used pro rata to manufacture specific low-density adhesives/sealants, for example one can utilize plastic microspheres, preferably in pre-expanded form. These types of microspheres can either be added directly to the adhesive/sealant in the prefoamed form or the microspheres in the non-foamed form are added as a finely dispersed powder to the adhesive/sealant. These microspheres comprise an aliphatic hydrocarbon or fluorohydrocarbon-based liquid blowing agent as the core and a skin of a copolymer of acrylonitrile with vinylidene chloride and/or methyl methacrylate and/or methacrylonitrile. The addition of such non-foamed microspheres results in their expansion and consequently a foaming during the curing process of the adhesive/sealant. The method results In a very uniform and fine porous foaming. The use of this type of microspheres is described, for example, in EP-A-559254. These types of microspheres are commercially available, e.g., under the trade name “Expancel” from Nobel Industries or under the trade name “Dualite” from Pierce & Stevens Company (now part of Henkel Corporation).

In addition, additives for regulating the flow behavior can also be added, for example urea derivatives, fibrillated or pulped short fibers, pyrogenic silicas and the like.

Although the inventively used adhesives/sealants preferably do not comprise plasticizers, sometimes it may be necessary to also use known plasticizers. Dialkyl phthalates, dialkyl adipates, dialkyl sebacates, alkylaryl phthalates, alkyl benzoates, dibenzoates of polyols, like ethylene glycol, propylene glycol or the lower polyoxypropylene- or polyoxyethylene compounds can be used here. Further suitable plasticizers, alkyl phosphates, aryl phosphates or alkyl aryl phosphates as well as allylsulfonic acid esters of phenol or also paraffinic or naphthenic oils or dearomatized hydrocarbons can be used as thinners. It is important when using plasticizers as co-agents that they be selected such that they will not attack the deactivating surface layer of the deactivated finely dispersed polyisocyanates during storage of the adhesive/sealant, as this would provoke a premature curing of the adhesive/sealant.

The inventive choice of suitable radiation frequencies enables various advantages to be achieved.
1. Radiation energy is preferably or exclusively absorbed by the adhesive. The substrates are only indirectly heated by thermal conduction and therefore remain significantly cooler than in the case of oven curing.
2. With the complete absorption of the emitted energy directly in the adhesive, there results a markedly faster curing than in the oven, particularly if the adhesive must be cured between 2 substrates. Curing times of less than 10 minutes in an oven are barely achievable. Under favorable conditions, less than two, in the ideal case less than one minute are required for microwave curing.

Surprisingly, it was moreover discovered that the curing temperatures for the polyurethanes lie significantly lower than in oven curing. Differences of 10° C. and more in the surface temperature were found when the values were determined immediately after leaving the energy source. The values measured after switching off the microwave field were also markedly lower than those laboratory values determined by measuring the thickening temperature.

The inventive process for curing one-component adhesives/sealants is particularly suitable for adhesively joining plastic substrates. Particularly preferably, this process for adhesively joining plastic components can be employed in the automobile industry, for example for attached parts and mounted parts such as roof modules, trunk lids, door parts as well as headlight components.

The inventive process is described below in more detail using several examples.

### EXAMPLES

### Example 1

Castor oil (10 g), 220 g of OH-terminated polybutadiene (e.g., LIQUIFLEX H), and 264 g of a process oil (e.g., NYTEX 840) are mixed in a stirred vessel.
   Subsequently, the Following Additives are Stirred in:
Aminopropyl trimethoxysilane, 1 g;
Dimethyltin carboxylate (FOMREZ UL-28), 1 g;
2-Methyl-2-azanorbornane (DABCO AN10) 1.5 g; and
Polyoxypropylenetriamine (JEFFAMINE T403), 2.5 g.
   The Following Solids are then Dispersed into the Above-Described Mixture Under Vacuum:
Powdered molecular sieve, 30 g
Silica, 15 g,
Coloring carbon black, 5 g,
Surface-treated chalk, 410 g.
   In the last step, 40 g of dimeric toluylene diisocyanate (METALINK U) are stirred in, under vacuum, to homogeneity. A pasty mass with a thickening temperature of ca. 80° C. is obtained.

The product was tested for suitability in adhesively joining headlight substrates. Test pieces of polypropylene and polycarbonate were used, a trail of adhesive according to example 1 was dispensed onto the polypropylene part and the polycarbonate was added onto it. The pieces were then conveyed through a microwave tunnel in which was a low energy microwave fundamental radiation of 2.45 GHz with an available second frequency of 1.6 GHz modulated onto it. The curing between both the plastic pieces (adhesion of PP to PC) was completed after ca. 2 minutes.

The surface temperature was determined by curing freestanding trails under the same conditions. The temperature, measured immediately after leaving the microwave tunnel, was 68° C. In the oven, the product was cured after 15 minutes at 78° C.; at lower temperatures, the mass remained pasty.

What is claimed is:

1. A process for curing a one-component adhesive/sealant comprising at least one surface-deactivated solid polyisocyanate, said process comprising exposing the adhesive/sealant to microwave radiation, wherein the adhesive/sealant is heated to a material temperature below the thickening temperature.

2. A process according to claim 1, wherein immediately after the end of the microwave irradiation, the adhesive/sealant has a material temperature between 40° C. and 120° C.

3. A process according to claim 1, wherein immediately after the end of the microwave irradiation, the adhesive/sealant has a material temperature between 50° C. and 70° C.

4. A process according to claim 1, wherein the adhesive/sealant is simultaneously irradiated with microwaves of at least two wavelengths.

5. A process according to claim 4, wherein the at least two wavelengths of the microwaves are generated by switching on microwave producing microwave sources.

6. A process according to claim 5, wherein the switching on is periodic.

7. A process according to claim 1, wherein the energy of the microwaves is controlled as a function of the resulting adhesive/sealant temperature and/or the state of cure of the adhesive/sealant.

8. A process according to claim 1, wherein the adhesive/sealant is on a substrate and the substrate is successively conveyed through a plurality of zones that are irradiated with microwaves having an identical fundamental frequency and which are modulated with at least two different modulation frequencies.

9. A process in accordance with claim 8, wherein said identical fundamental frequency is about 2.5 Gigahertz.

10. A process in accordance with claim 8, wherein said at least two different modulation frequencies are selected from the group consisting of about 1.2 Gigahertz, about 1.6 Gigahertz, about 1.9 Gigahertz, about 2.1 Gigahertz, about 2.5 Gigahertz and about 3 Gigahertz.

11. A process according to claim 1, wherein the at least one surface-deactivated polyisocyanate has a melting point above 40° C.

12. A process according to claim 1, wherein the polyisocyanate is selected from diphenylmethane-4,4′-diisocyanate (MDI), naphthalene-1,5-diisocyanate (NDI), 3,3′-dimethyl-biphenyl-4,4′-diisocyanate (TODI), dimeric 1-methyl-2,4-phenylene diisocyanate (TDI-U), 3,3′-diisocyanato-4,4′-dimethyl-N,N′-diphenylurea (TDIH), the isocyanurate of IPDI (IPDI-T) or the addition product of 2 moles 1-methyl-2,4-phenylene diisocyanate with 1 mole 1,2-ethanediol, 1,4-butanediol, 1,4-cyclohexanedimethanol or ethanolamine.

13. A process according to claim 1, wherein the at least one surface-deactivated polyisocyanate is produced by dispersing a powdered polyisocyanate in a solution or dispersion of at least one deactivation agent.

14. A process according to claim 13, wherein at least one low molecular weight liquid polyamine, polyamidoamine, polyoxyalkyleneamine, aminoalkyl alkoxysilane is employed as said at least one deactivation agent.

15. A process according to claim 1, wherein the adhesive/sealant is additionally comprised of at least one hydroxy-functional natural oil and/or hydroxy-functional polyene selected from hydroxy-functional polybutadienes, hydroxy-functional polyisoprenes, hydroxy-functional copolymers of butadiene, isoprene and styrene, or hydrogenated products thereof.

16. A process in accordance with claim 1, wherein said at least one surface-deactivated polyisocyanate is in the form of a powder having an average particle size of 10 μm or less.

17. A process in accordance with claim 1, wherein said adhesive/sealant is additionally comprised of at least one polyol selected from the group consisting of polyether polyols, polyester polyols, polyacrylate polyols, polyolefin polyols and polyether ester polyols.

18. A process in accordance with claim 1, wherein said adhesive/sealant is additionally comprised of at least one amine selected from the group consisting of polyether amines and substituted aromatic diamines.

19. A process for adhesively joining a first plastic substrate and a second plastic substrate using a one-component adhesive/sealant comprising at least one surface-deactivated solid polyisocyanate, said process comprising curing the adhesive/sealant by exposing the adhesive/sealant to microwave radiation, wherein the adhesive/sealant is heated to a material temperature below the thickening temperature.

20. A process in accordance with claim 19, wherein the first plastic substrate and second plastic substrate are headlight components.

21. A process in accordance with claim 19, wherein said adhesive/sealant is dispensed onto a surface of at least one of said first plastic substrate or said second plastic substrate using a dispensing device conveyed on an arm of a robot and wherein a microwave emitter conveyed on said arm of said robot is used as a source of the microwave radiation.
